(19) United States
(12) Patent Application Publication
(10) Pub. No.: US 2025/0049130 A1
(43) Pub. Date: Feb. 13, 2025

(54) AEROSOL GENERATING SYSTEM AND METHOD FOR PRODUCING AEROSOL GENERATING SYSTEM

(71) Applicant: Japan Tobacco Inc., Tokyo (JP)

(72) Inventors: Hitoshi TAMBO, Tokyo (JP); Yasunobu INOUE, Tokyo (JP)

(73) Assignee: Japan Tobacco Inc., Tokyo (JP)

(21) Appl. No.: 18/932,676

(22) Filed: Oct. 31, 2024

Related U.S. Application Data
(63) Continuation of application No. PCT/JP2022/020019, filed on May 12, 2022.

(51) Int. Cl. A24F 40/46

(52) U.S. Cl. CPC A24F 40/46

(57) ABSTRACT

This aerosol generating system includes a cylindrical member having an opening into which an aerosol generating article containing an aerosol source is inserted, a membranal heating part disposed on the outer side surface of the cylindrical member, and a heat diffusion layer in which a first layer having heat conductivity equal to or higher than a first threshold and a second layer having tensile strength equal to or higher than a second threshold are laminated, wherein the heat diffusion layer is disposed such that the heat diffusion layer is wound to cover the outer side of the heating part disposed on the outer side surface of the cylindrical member in the state where the first layer faces inward and the second layer faces outward.

### CROSS-REFERENCE TO RELATED APPLICATION

This application is a Continuation of PCT International Application No. PCT/JP2022/020019, filed on May 12, 2022, which is hereby expressly incorporated by reference into the present application.

### TECHNICAL FIELD

The present invention relates to an aerosol generating system and a method for producing the aerosol generating system.

### BACKGROUND ART

Inhaler devices, such as e-cigarettes and nebulizers, that generate material to be inhaled by a user are widespread. For example, an inhaler device generates an aerosol having a flavor component imparted thereto, by using a substrate including an aerosol source for generating the aerosol and a flavor source for imparting the flavor component to the generated aerosol. A user can enjoy the flavor by inhaling the aerosol having the flavor component imparted thereto, which is generated by the inhaler device. The user's action of inhaling an aerosol will be hereinafter also referred to as a puff or a puff action.

Typically, an aerosol is generated by heating a substrate. For example, PTL 1 given below discloses a technology for heating a substrate using a single film heater wrapped in a tubular shape to surround the substrate.

### CITATION LIST

### Patent Literature

Patent Literature 1: JP 6210610

### SUMMARY OF INVENTION

### Technical Problem

According to the technology disclosed in PTL 1 given above, the film heater is wrapped around a tubular member that accommodates the substrate. However, it may be difficult to appropriately heat the substrate when the film heater is simply wrapped around the tubular member.

The present invention has been made in light of the above-described problem, and an object of the present invention is to provide a system capable of heating the substrate more appropriately.

### Solution to Problem

To achieve the above-described object, an aspect of the present invention provides an aerosol generating system including a tubular member having an opening allowing insertion of an aerosol generating article containing an aerosol source; a heater that is film-shaped and disposed on an outer side surface of the tubular member; and a heat diffusion layer in which a first layer and a second layer are laminated together, the first layer having a heat conductivity greater than or equal to a first threshold, the second layer having a tensile strength greater than or equal to a second threshold. The heat diffusion layer is wrapped to cover an outer side of the heater disposed on the outer side surface of the tubular member such that the first layer is on an inner side and the second layer is on an outer side.

The second layer may be longer than the first layer in a circumferential direction of the tubular member. The heat diffusion layer may be formed by bonding the first layer and the second layer such that the second layer covers the first layer over an entire region in the circumferential direction of the tubular member.

The second layer may include a first portion that is longer than the first layer in a height direction of the tubular member. End portions of the first portion of the second layer protruding from the first layer in the height direction of the tubular member may be bonded to the heater.

The heater may include an electrically insulating substrate that is film-shaped, and a conductive track disposed on the electrically insulating substrate. The end portions of the first portion of the second layer may be bonded to blank regions of the heater in which the conductive track is not disposed, the blank regions being adjacent, in the height direction of the tubular member, to a region of the heater in which a heat-producing portion of the conductive track is disposed, the heat-producing portion producing heat when a current is applied.

The second layer may include a second portion that is longer than an outer circumference of the tubular member in a circumferential direction of the tubular member. The second portion of the second layer may include a protruding portion protruding from the first layer in the circumferential direction of the tubular member, the protruding portion being bonded to a portion of the second layer that is one turn inward from the protruding portion.

The second portion of the second layer may be shorter than the first layer in a height direction of the tubular member.

The first layer may be longer than an outer circumference of the tubular member in a circumferential direction of the tubular member.

The heater may include an electrically insulating substrate that is film-shaped, and a conductive track disposed on the electrically insulating substrate. The heater may be disposed on the outer side surface of the tubular member such that a portion of the outer side surface of the tubular member is covered and that another portion of the outer side surface of the tubular member is exposed.

The heater may be formed in a T-shape or a shape having a cutout in plan view.

The aerosol generating system may further include a heat-insulating layer having a heat conductivity less than a third threshold, and a thermal contraction tube that contracts when heated. The heater and the heat diffusion layer may be fixed to the tubular member by the thermal contraction tube such that the heater and the heat diffusion layer are wrapped around the outer side surface of the tubular member and covered by the heat-insulating layer.

The first layer may be made of copper, graphite, or aluminum.

The second layer may be made of polyimide (PI).

The tubular member may be made of steel use stainless (SUS).

In addition to achieve the above-described object, another aspect of the present invention provides a method for producing an aerosol generating system. The method includes bonding a heat diffusion layer in which a first layer and a second layer are laminated together to a heater that is film-shaped such that the first layer is on an inner side, the first layer having a heat conductivity greater than or equal to a first threshold, the second layer having a tensile strength greater than or equal to a second threshold; and placing the heater and the heat diffusion layer that are bonded together on an outer side surface of a tubular member having an opening such that the heater is on an inner side, the opening allowing insertion of an aerosol generating article containing an aerosol source.

### Advantageous Effects of Invention

As described above, the present invention provides a system capable of heating the substrate more appropriately.

### BRIEF DESCRIPTION OF DRAWINGS

FIG. 1 is a schematic diagram illustrating a configuration example of an inhaler device.

FIG. 2 is a schematic perspective view illustrating an example of a heater assembly according to the present embodiment.

FIG. 3 is a schematic diagram illustrating an example of a cross-section of the heater assembly taken along line A-A.

FIG. 4 is a schematic perspective view illustrating an example of a container according to the present embodiment.

FIG. 5 is a development view of an example of a heater according to the present embodiment.

FIG. 6 is a development view of a heat diffusion sheet according to the present embodiment.

FIG. 7 is a flowchart of an example of a method for producing the heater assembly according to the present embodiment.

FIG. 8 is a schematic diagram illustrating the example of the method for producing the heater assembly according to the present embodiment.

FIG. 9 is a schematic diagram illustrating an example of a cross-section of a heater assembly according to a first supplement.

FIG. 10 is a schematic perspective view illustrating an example of a heater assembly according to a second supplement.

FIG. 11 is a perspective view illustrating an example of a heater 40 according to the second supplement before attachment to an outer side surface of a container.

FIG. 12 is a perspective view illustrating an example of the heater 40 according to the second supplement after attachment to the outer side surface of the container.

### DESCRIPTION OF EMBODIMENTS

A preferred embodiment of the present invention will now be described in detail with reference to the accompanying drawings. In the specification and the drawings, structural elements having substantially the same functional configuration are denoted by the same reference signs, and redundant description thereof will be omitted.

### <1. Configuration Example of Inhaler Device>

An inhaler device generates material to be inhaled by a user. In the example described below, the material generated by the inhaler device is an aerosol. Alternatively, the material generated by the inhaler device may be gas.

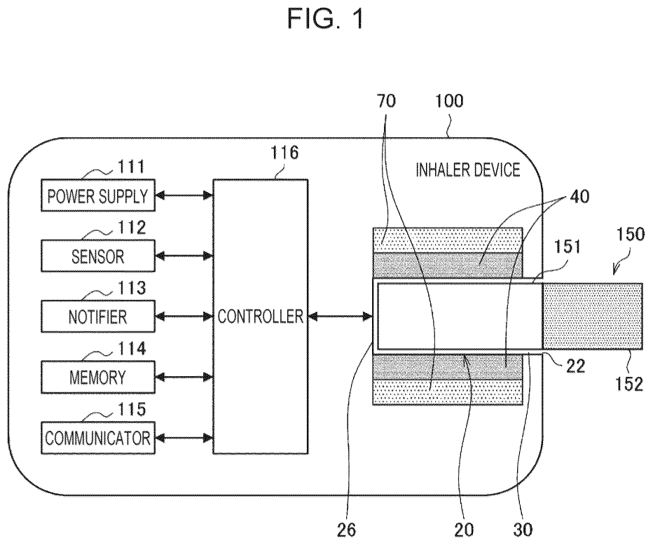

FIG. 1 is a schematic diagram illustrating a configuration example of an inhaler device. As illustrated in FIG. 1, an inhaler device 100 according to the present configuration example includes a power supply 111, a sensor 112, a notifier 113, a memory 114, a communicator 115, a controller 116, a container 20, a heater 40, and a heat insulator 70.

The power supply 111 stores electric power. The power supply 111 supplies electric power to the structural elements of the inhaler device 100 under the control of the controller 116. The power supply 111 may be a rechargeable battery such as a lithium ion secondary battery.

The sensor 112 acquires various items of information regarding the inhaler device 100. In an example, the sensor 112 may be a pressure sensor such as a condenser microphone, a flow sensor, or a temperature sensor, and acquire a value generated in accordance with the user's inhalation. In another example, the sensor 112 may be an input device that receives information input by the user, such as a button or a switch.

The notifier 113 provides information to the user. The notifier 113 may be a light-emitting device that emits light, a display device that displays an image, a sound output device that outputs sound, or a vibration device that vibrates.

The memory 114 stores various items of information for operation of the inhaler device 100. The memory 114 may be a non-volatile storage medium such as flash memory.

The communicator 115 is a communication interface capable of communication in conformity with any wired or wireless communication standard. Such a communication standard may be, for example, Wi-Fi (registered trademark), Bluetooth (registered trademark), Bluetooth Low Energy (BLE) (registered trademark), near-field communication (NFC), or a standard using a low-power wide-area network (LPWAN).

The controller 116 functions as an arithmetic processing unit and a control circuit, and controls the overall operations of the inhaler device 100 in accordance with various programs. The controller 116 includes an electronic circuit such as a central processing unit (CPU) or a microprocessor, for example.

The container 20 has an internal space 30, and holds a stick substrate 150 in a manner such that the stick substrate 150 is partially accommodated in the internal space 30. The container 20 is structured such that the stick substrate 150 can be inserted into the container 20 through an opening 22. The container 20 has the opening 22 that allows the internal space 30 to communicate with the outside, and accommodates the stick substrate 150 inserted into the internal space 30 through the opening 22. For example, the container 20 may be a tubular member having the opening 22 and a bottom wall 26 on its ends, and may define the pillar-shaped internal space 30. The container 20 connects with an airflow path that supplies air to the internal space 30. For example, a side surface of the inhaler device 100 has an air inlet hole that is an inlet of air into the airflow path. For example, the bottom wall 26 has an air outlet hole that is an outlet of the air from the airflow path to the internal space 30.

The stick substrate 150 includes a substrate 151 and an inhalation port 152. The substrate 151 includes an aerosol source. The aerosol source includes a flavor component that is either derived from tobacco or not derived from tobacco. For the inhaler device 100 that is a medical inhaler such as a nebulizer, the aerosol source may include a medicine. For example, the aerosol source may be a liquid including the flavor component that is either derived from tobacco or not derived from tobacco, such as polyhydric alcohol or water. Examples of the polyhydric alcohol include glycerine and propylene glycol. Alternatively, the aerosol source may be a solid including the flavor component that is either derived from tobacco or not derived from tobacco. The stick substrate 150 held by the container 20 includes the substrate 151 at least partially accommodated in the internal space 30 and the inhalation port 152 at least partially protruding from the opening 22. When the user inhales with the inhalation port 152 protruding from the opening 22 in his/her mouth, air flows into the internal space 30 through the airflow path (not illustrated), and the air and an aerosol generated from the substrate 151 reach inside the mouth of the user.

The heater 40 heats the aerosol source to atomize the aerosol source and generate the aerosol. In the example illustrated in FIG. 1, the heater 40 is film-shaped and disposed to cover the outer circumference of the container 20. When the heater 40 produces heat, the substrate 151 of the stick substrate 150 is heated from the outside, and the aerosol is generated. The heater 40 produces heat when receiving electric power from the power supply 111. In an example, the electric power may be supplied in response to the sensor 112 detecting a start of the user's inhalation and/or an input of predetermined information. Subsequently, the supply of the electric power may be stopped in response to the sensor 112 detecting an end of the user's inhalation and/or an input of predetermined information.

The heat insulator 70 prevents heat from transferring from the heater 40 to the other structural elements. For example, the heat insulator 70 may be a vacuum heat insulator or an aerogel heat insulator.

The inhaler device 100 and the stick substrate 150 operate together to generate the aerosol to be inhaled by the user. Thus, the combination of the inhaler device 100 and the stick substrate 150 may be regarded as an aerosol generating system. The stick substrate 150 is an example of an aerosol generating article that contains an aerosol source and generates an aerosol.

### <2. Detailed Structure of Heater Assembly>

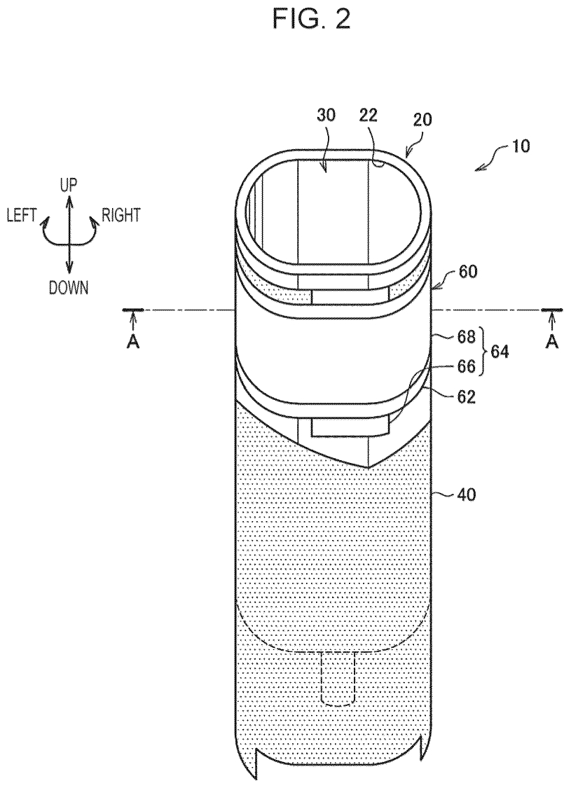

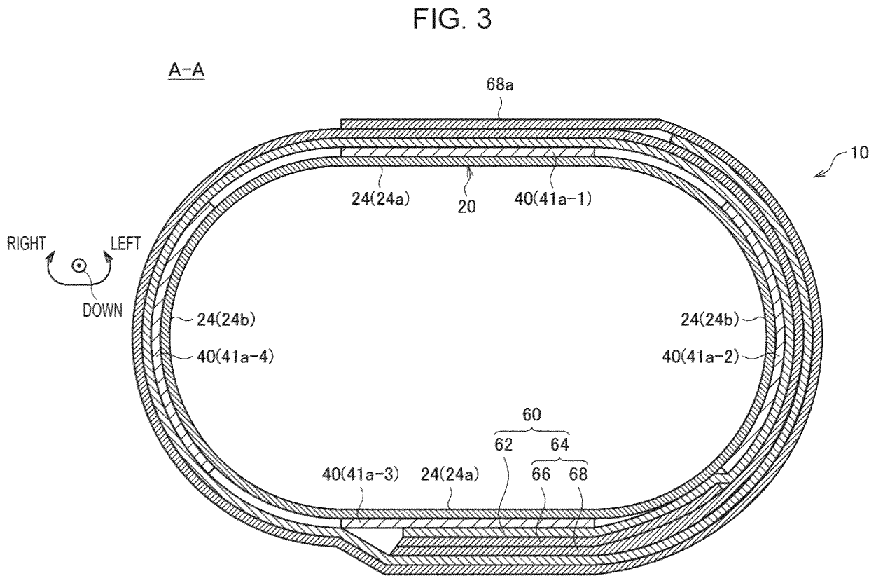

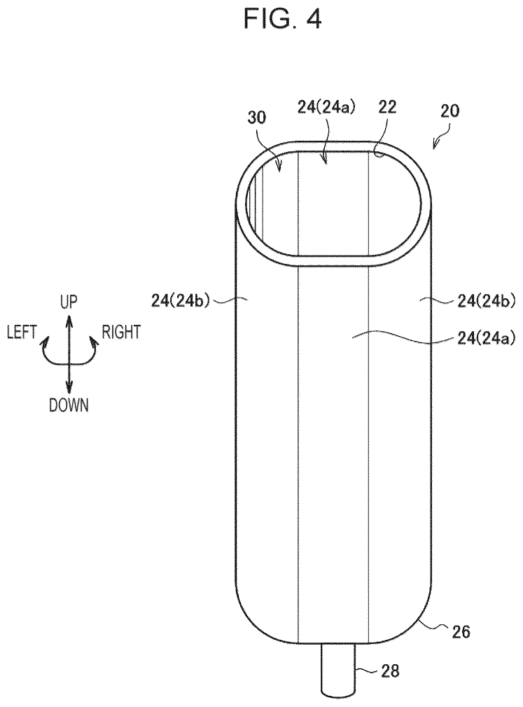

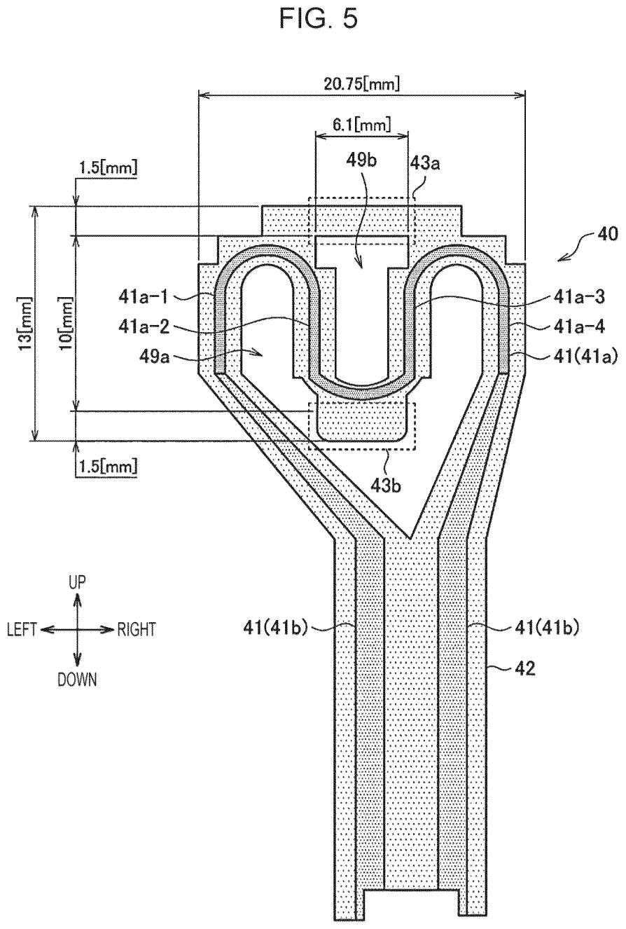

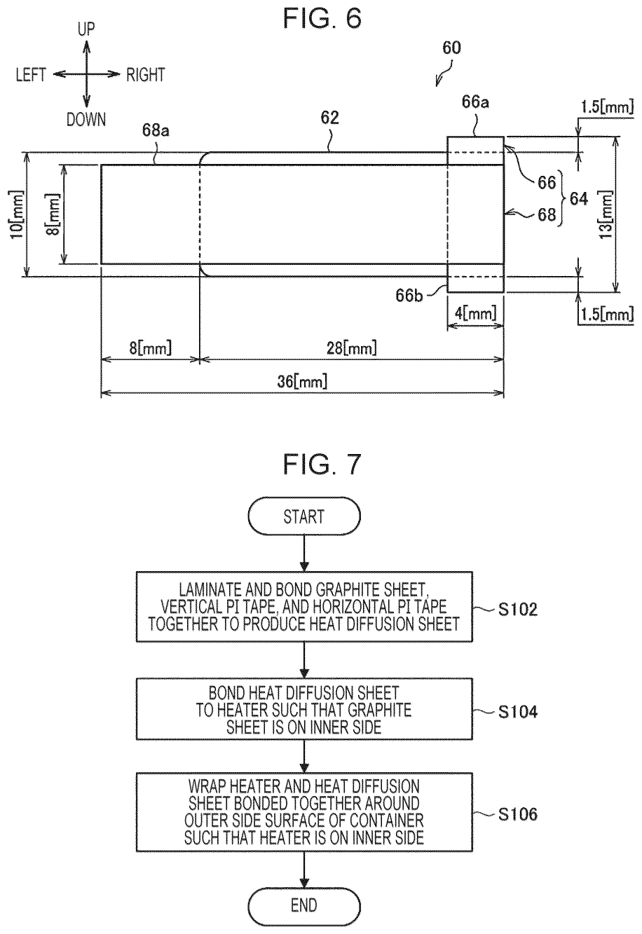

The physical structure of the inhaler device 100 according to the present embodiment will now be described in detail with reference to FIGS. 2 to 6. FIG. 2 is a schematic perspective view illustrating an example of a heater assembly 10 according to the present embodiment. FIG. 3 is a schematic diagram illustrating an example of a cross-section of the heater assembly 10 taken along line A-A. FIG. 4 is a schematic perspective view illustrating an example of the container 20 according to the present embodiment. FIG. 5 is a development view of an example of the heater 40 according to the present embodiment. FIG. 6 is a development view of a heat diffusion sheet 60 according to the present embodiment. FIGS. 5 and 6 show dimensions in millimeters [mm]. The container 20 has an outer circumference of 23.3 [mm].

In these diagrams, the height direction of the container 20 (in other words, the direction in which the stick substrate 150 is inserted and removed) is also referred to as an up-down direction. The direction of the container 20 toward the opening 22 is referred to as upward, and the direction toward the bottom wall 26 is referred to as downward. The circumferential direction of the container 20 is also referred to as a left-right direction. When viewed in the direction from the opening 22 to the bottom wall 26, the clockwise direction is referred to as leftward, and the counterclockwise direction is referred to as rightward.

The heater assembly 10 is one of the components constituting the inhaler device 100. The heater assembly 10 is a component specifically involved in heating the stick substrate 150. As illustrated in FIG. 2, the heater assembly 10 includes the container 20, the heater 40, and the heat diffusion sheet 60. More specifically, as illustrated in FIGS. 2 and 3, the heater assembly 10 is formed by wrapping the heater 40 and the heat diffusion sheet 60 around an outer side surface of the container 20.

As illustrated in FIG. 4, the container 20 is a bottomed tubular member having the opening 22, a side wall 24, and the bottom wall 26 that closes the end opposite to the opening 22. The bottom wall 26 has a hole (not illustrated), to which a tubular airflow path 28 is connected. The stick substrate 150 is inserted into the container 20 through the opening 22, and is accommodated in the internal space 30 surrounded by the side wall 24 and the bottom wall 26. The container 20 is made of a material with predetermined heat transfer properties, such as steel use stainless (SUS). Thus, the stick substrate 150 can be efficiently heated.

As illustrated in FIG. 4, the side wall 24 of the container 20 includes two flat portions 24a having a flat shape and two curved portions 24b having a curved shape. As illustrated in FIG. 3, the container 20 may have a substantially elliptical shape along a plane orthogonal to the up-down direction. More specifically, in a plane orthogonal to the up-down direction, each of the two flat portions 24a may be a straight line, and each of the two curved portions 24b may be a semicircular arc. The distance between the inner surfaces of the two flat portions 24a is preferably less than the width of the stick substrate 150. In such a case, the container 20 can hold the stick substrate 150 while pressing the stick substrate 150 between the two flat portions 24a.

As illustrated in FIG. 5, the heater 40 includes a conductive track 41 and an electrically insulating substrate 42. The conductive track 41 is a circuit made of a conductive material. The electrically insulating substrate 42 is a film-shaped substrate made of an insulating material. The insulating material may be, for example, polyimide (PI). The heater 40 may be formed by placing the conductive track 41 on the film-shaped electrically insulating substrate 42. For example, the heater 40 may be a film heater formed by sandwiching the conductive track 41 between two PI films that constitute the electrically insulating substrate 42. Other examples of the insulating material include polyethylene terephthalate (PET) and fluorocarbon resin.

As illustrated in FIG. 5, the conductive track 41 includes a heat-producing portion 41a and non-heat-producing portions 41b. The heat-producing portion 41a is a portion of the conductive track 41 that produces heat when a current is applied. The non-heat-producing portions 41b are portions of the conductive track 41 that do not produce heat or produce very small amount of heat when a current is applied. In other words, the heat-producing portion 41a has an electrical resistance higher than the electrical resistance of the non-heat-producing portions 41b. For example, the heat-producing portion 41a may be narrow, and the non-heat-producing portions 41b may be wide. In this case, the above-described relationship between the electrical resistances can be achieved. The heat-producing portion 41a may be made of, for example, steel use stainless (SUS). The non-heat-producing portions 41b may be made of, for example, a material containing at least one of copper or nickel. More specifically, the non-heat-producing portions 41b may be formed by plating SUS with copper and nickel. In this case, for example, the thickness of SUS may be 30 μm, the thickness of nickel may be 30 μm, and the thickness of copper may be 5 μm. This structure can also achieve the above-described relationship between the electrical resistances. In addition, the thermal resistance of the heat-producing portion 41a can be increased. The materials of the conductive track 41 are, of course, not limited to the above-described examples, and other materials, such as aluminum, may also be used.

The heater 40 is disposed on the container 20 such that a portion of the outer side surface of the container 20 is covered and another portion of the outer side surface of the container 20 is exposed. More specifically, as illustrated in FIG. 5, the heater 40 may be shaped to have cutouts 49a and 49b in plan view. In such a case, the heater 40 covers the outer side surface of the container 20 in regions excluding the cutouts 49a and 49b. The outer side surface of the container is exposed at the cutouts 49a and 49b. According to this structure, when the outer side surface of the container 20 includes uneven regions, the heater 40 can be brought into close contact with the outer side surface of the container 20 while placing the uneven regions of the container 20 in the cutouts 49a and 49b. When the cutouts 49a and 49b are not provided, a portion of the heater is raised in the uneven regions of the outer side surface of the container 20, and the heater 40 may be damaged due to rapid increase in the temperature of the raised portion. In contrast, according to the above-described structure, the heater 40 comes into close contact with the outer side surface of the container 20, so that damage to the heater 40 can be prevented.

As illustrated in FIG. 5, the electrically insulating substrate 42 has the cutouts 49a and 49b. The conductive track 41 is disposed on the electrically insulating substrate 42 so as to extend around the cutouts 49a and 49b. More specifically, the conductive track 41 is disposed on the electrically insulating substrate 42 such that the conductive track 41 starts from the lower end, extends along the electrically insulating substrate 42 while bypassing the cutouts 49a and 49b, and returns to the lower end. The conductive track 41 on the electrically insulating substrate 42 is exposed at the lower end of the heater 40, and is electrically connected to the power supply 111. In the example illustrated in FIG. 5, the conductive track 41 has an M-shape including three bends in the heat-producing portion 41a. As illustrated in FIG. 3, heat-producing portions 41a-1 to 41a-4 corresponding to four linear portions disposed on both sides of the three bends of the M-shape may be disposed on the outer side surface of the container 20 with equal intervals therebetween. The number of bends of the conductive track 41 is, of course, not limited to 3, and may be any number of one or more.

As illustrated in FIG. 6, the heat diffusion sheet 60 includes a graphite sheet 62 and a PI tape 64 that are laminated together. The heat diffusion sheet 60 is an example of a heat diffusion layer formed in a film shape. The heat diffusion sheet 60 has a function of diffusing heat. As illustrated in FIGS. 2 and 3, the heat diffusion sheet 60 is wrapped to cover the outer side of the heater 40, which is wrapped around the outer side surface of the container 20. According to this structure, the heat of the heater 40 can be diffused over the entirety of the container 20. As a result, the stick substrate 150 accommodated in the container 20 can be efficiently heated.

The graphite sheet 62 is a sheet-shaped member made of graphite. The graphite sheet 62 is an example of a first layer having a heat conductivity greater than or equal to a first threshold. The heat conductivity of the graphite sheet 62 is preferably at least greater than the heat conductivity of the container 20. The first threshold may be, for example, 50 [W/(m·K)], preferably 100 [W/(m·K)]. The heat conductivity of the graphite sheet 62 in a surface direction is preferably greater than or equal to the first threshold. The heat conductivity of the graphite sheet 62 in a thickness direction is not particularly limited. This is because heat conduction in the thickness direction is limited by the electrically insulating substrate 42. For example, the graphite sheet 62 may have a thickness of 40 [μm], and the heat conductivity thereof may be 1500 [W/(m·K)] in the surface direction and 5 [W/(m. K)] in the thickness direction. According to this structure, the graphite sheet 62 can efficiently transmit the heat of the heater 40 over the entire region of the container 20.

The PI tape 64 is a tape made of PI. The PI tape 64 is formed by applying an adhesive to one surface of a film-shaped member made of PI. The PI tape 64 is an example of a second layer having a tensile strength greater than or equal to a second threshold. The tensile strength of the PI tape 64 is preferably at least higher than the tensile strength of the graphite sheet 62. The second threshold may be, for example, 60 [MPa], preferably 120 [MPa], in a normal temperature environment. These examples of the second threshold are tensile strengths in a length direction when the PI tape 64 is 25 mm wide. According to this structure, the PI tape 64 can prevent tearing of the graphite sheet 62 during assembly. 25

As illustrated in FIG. 6, the PI tape 64 includes a vertical PI tape 66 and a horizontal PI tape 68. The vertical PI tape 66 is an example of a first portion of the PI tape 64. The horizontal PI tape 68 is an example of a second portion of the PI tape 64.

The heat diffusion sheet 60 is formed by stacking and bonding together the graphite sheet 62 as the bottom layer, the vertical PI tape 66 as the middle layer, and the horizontal PI tape 68 as the top layer. The vertical PI tape 66 and the horizontal PI tape 68 are stacked together such that adhesive surfaces thereof face the bottom layer. The graphite sheet 62, the vertical PI tape 66, and the horizontal PI tape 68 are stacked together such that the right ends thereof are aligned and the centers thereof in the up-down direction are also aligned. Here, when the heat diffusion sheet 60 is wrapped around the container 20, the inner layer is the bottom layer and the outer layer is the top layer.

In the example illustrated in FIG. 6, the graphite sheet 62 has a length of 10 mm in the up-down direction and a length of 28 mm in the left-right direction. The vertical PI tape 66 has a length of 13 mm in the up-down direction and a length of 4 mm in the left-right direction. The horizontal PI tape 68 has a length of 8 mm in the up-down direction and a length of 36 mm in the left-right direction.

The heat diffusion sheet 60 is wrapped to cover the outer side of the heater 40, which is disposed on the outer side surface of the container 20, such that the graphite sheet 62 is on the inner side and the PI tape 64 is on the outer side. In other words, the heater 40, the graphite sheet 62, and the PI tape 64 are wrapped around the outer side surface of the container 20 in that order. According to this structure, the graphite sheet 62 can be disposed in close contact with the heater or the container 20. As a result, the effect of diffusing heat from the heater 40 to the container through the graphite sheet 62 can be enhanced. In addition, according to this structure, the graphite sheet 62 in close contact with the heater 40 or the container 20 can be protected from the outside by the PI tape 64. As a result, the effect of preventing the tearing of the graphite sheet 62 by the PI tape 64 can be enhanced.

The length of the graphite sheet 62 in the left-right direction is longer than the outer circumference of the container 20. More specifically, the length of the graphite sheet 62 in the left-right direction is 28 [mm], and the outer circumference of the container 20 is 23.3 [mm]. As a result, as illustrated in FIG. 3, the graphite sheet 62 is wrapped one or more turns around the outer side surface of the container 20. According to this structure, the graphite sheet 62 covers the entire outer circumference of the container 20, and heat from the heater 40 can be diffused over the entire outer circumference of the container 20.

The length of the horizontal PI tape 68 in the left-right direction is longer than the outer circumference of the container 20. More specifically, the length of the horizontal PI tape 68 in the left-right direction is 36 [mm], and the outer circumference of the container 20 is 23.3 [mm]. According to this structure, the horizontal PI tape 68 is wrapped one or more turns around the container 20, so that the graphite sheet 62 can be more securely fixed.

As illustrated in FIG. 6, the PI tape 64 (in particular, the horizontal PI tape 68) is longer than the graphite sheet 62 in the left-right direction. More specifically, the length of the horizontal PI tape 68 in the left-right direction is 36 [mm], and the length of the graphite sheet 62 in the left-right direction is 28 [mm]. The heat diffusion sheet 60 is formed by bonding the graphite sheet 62 and the PI tape 64 together such that the PI tape 64 (in particular, the horizontal PI tape 68) covers the graphite sheet 62 over the entirety thereof in the left-right direction. As described below, the heat diffusion sheet 60 is wrapped around the outer side surface of the container 20 by rotating the container 20 while the heat diffusion sheet 60 is pressed against the container 20 with a rubber roller or the like. According to this structure, when the heat diffusion sheet 60 is wrapped around the container 20, the rubber roller can be brought into contact only with the PI tape 64 and not with the graphite sheet 62. Accordingly, the force applied to the graphite sheet 62 can be reduced to prevent the graphite sheet 62 from breaking.

As illustrated in FIG. 6, the horizontal PI tape 68 includes a protruding portion 68a protruding from the graphite sheet 62 in the left-right direction. As illustrated in FIG. 3, the protruding portion 68a is bonded to a portion of the PI tape 64 (in particular, the horizontal PI tape 68) that is one turn inward from the protruding portion 68a. According to this structure, the position of the graphite sheet 62 can be fixed by the horizontal PI tape 68. As a result, the graphite sheet 62 can be prevented from breaking due to excessive force applied to the graphite sheet 62.

In addition, as illustrated in FIG. 6, the horizontal PI tape 68 may be shorter than the graphite sheet 62 in the up-down direction. More specifically, the length of the horizontal PI tape 68 in the up-down direction is 8 [mm], and the length of the graphite sheet 62 in the up-down direction is 10 [mm]. According to this structure, the horizontal PI tape 68 can be prevented from protruding from the graphite sheet 62 in the up-down direction and coming into direct contact with the heater 40 or the container 20. Thus, the graphite sheet 62 can be secured with play. As a result, the graphite sheet 62 can be prevented from breaking due to excessive force applied to the graphite sheet 62.

As illustrated in FIG. 6, the vertical PI tape 66 is longer than the graphite sheet 62 in the up-down direction. More specifically, the length of the vertical PI tape 66 in the up-down direction is 13 [mm], and the length of the graphite sheet 62 in the up-down direction is 10 [mm]. Therefore, both end portions 66a and 66b of the vertical PI tape 66 in the up-down direction protrude from the graphite sheet 62 in the up-down direction. More specifically, the end portions 66a and 66b of the vertical PI tape 66 protrude from the graphite sheet 62 by 1.5 [mm] in the up-down direction. The end portions 66a and 66b of the vertical PI tape 66 protruding from the graphite sheet 62 in the up-down direction are bonded to the heater 40. According to this structure, the heat diffusion sheet 60 is fixed to the heater 40, so that the heater 40 and the heat diffusion sheet 60 can be prevented from being displaced from each other.

As illustrated in FIG. 5, the heater 40 includes blank regions 43a and 43b in which the conductive track 41 is not disposed and that are adjacent to the region in which the heat-producing portion 41a is disposed in the up-down direction. The blank regions 43a and 43b are regions constituted only by the electrically insulating substrate 42. The end portions 66a and 66b of the vertical PI tape 66 in the up-down direction are bonded to the blank regions 43a and 43b of the heater 40. When the heater 40 has the blank regions 43a and 43b to which the heat diffusion sheet 60 is to be bonded, the heat diffusion sheet 60 can be securely fixed to the heater 40.

More specifically, as illustrated in FIG. 5, the region in which the heat-producing portion 41a of the heater 40 is disposed has a size of 20.75 [mm] in the left-right direction and 10 [mm] in the up-down direction. The positions and sizes of the blank regions 43a and 43b of the heater 40 correspond to those of the end portions 66a and 66b of the vertical PI tape 66. More specifically, the blank region 43a having a size of 1.5 [mm] in the up-down direction and 6.1 [mm] in the left-right direction is disposed above the region in which the heat-producing portion 41a of the heater is disposed. The blank region 43b having a size of 1.5 [mm] in the up-down direction and 6.1 [mm] in the left-right direction is disposed below the region in which the heat-producing portion 41a of the heater 40 is disposed. The blank region 43a and the blank region 43b of the heater 40 are spaced from each other by 10 [mm] in the up-down direction. As a result, the length from the upper end of the blank region 43a to the lower end of the blank region 43b is 13 [mm], which is equal to the length of the vertical PI tape 66 in the up-down direction, and the length from the left end to the right end of each of the blank regions 43a and 43b is 6.1 [mm], which is longer than the length of the vertical PI tape 66 in the left-right direction. Thus, the end portions 66a and 66b of the vertical PI tape 66 in the up-down direction can be bonded to the blank regions 43a and 43b over the entireties thereof. In addition, the region of the heater 40 in which the heat-producing portion 41a is disposed and that has a length of 10 [mm] in the up-down direction can be wrapped with the graphite sheet 62, which also has a length of 10 [mm] in the up-down direction. According to this structure, the region of the heater 40 in which the heat-producing portion 41a is disposed can be entirely covered by the graphite sheet 62, so that the heat from the heater 40 can be efficiently diffused.

### <3. Method for Producing Heater Assembly>

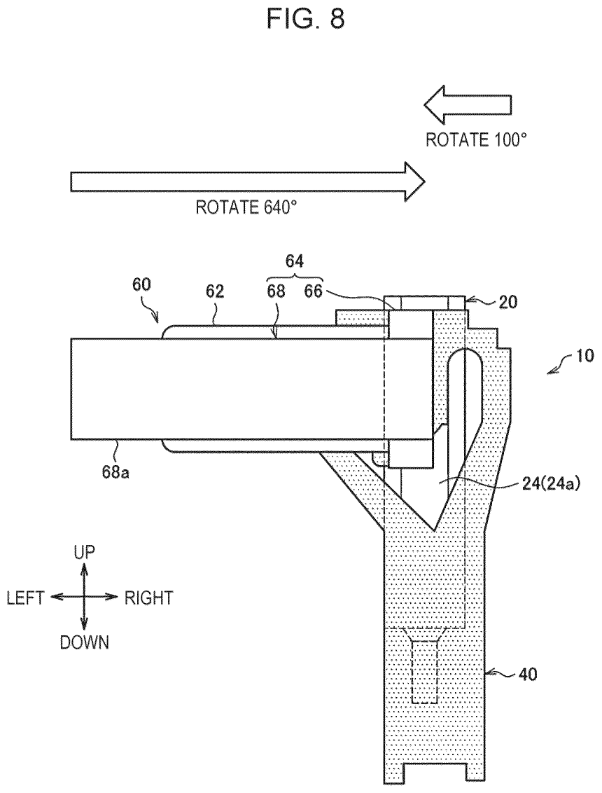

An example of a method for producing the heater assembly 10 will now be described with reference to FIGS. 7 and 8. FIG. 7 is a flowchart of the example of the method for producing the heater assembly 10 according to the present embodiment. FIG. 8 is a schematic diagram illustrating the example of the method for producing the heater assembly 10 according to the present embodiment.

The production method described below with reference to FIGS. 7 and 8 is performed by, for example, a machine tool. The machine tool may include a belt conveyor that conveys various components, an arm that holds and operates the components, a rotating machine that rotates the container 20, and a rubber roller that bonds the heater 40 and the heat diffusion sheet 60 to the outer side surface of the container 20 while pressing the heater 40 and the heat diffusion sheet 60 against the outer side surface of the rotating container 20.

As illustrated in FIG. 7, first, the machine tool laminates and bonds the graphite sheet 62, the vertical PI tape 66, and the horizontal PI tape 68 together to produce the heat diffusion sheet 60 (step S102).

Next, the machine tool bonds the heat diffusion sheet 60 to the heater 40 such that the graphite sheet 62 is on the inner side (step S104). More specifically, the machine tool bonds the end portions 66a and 66b of the vertical PI tape 66 in the up-down direction to the blank regions 43a and 43b of the heater 40.

Next, the machine tool wraps the heater 40 and the heat diffusion sheet 60 that are bonded together around the outer side surface of the container 20 such that the heater 40 is on the inner side (step S106). More specifically, first, as illustrated in FIG. 8, the machine tool bonds a portion of the heater 40 and the heat diffusion sheet 60, which are bonded together, to one of the flat portions 24a of the container 20. The bonded portion corresponds to the vertical PI tape 66. Next, as illustrated in FIG. 8, the machine tool rotates the container 20 leftward by 100°, and then rightward by 640°. At this time, the machine tool rotates the container 20 while pressing the heater 40 and the heat diffusion sheet 60 against the outer side surface of the container 20 with the rubber roller. Thus, the heater 40 and the heat diffusion sheet 60 can be appropriately bonded to the outer side surface of the container 20.

### <4. Supplement>

While a preferred embodiment of the present invention has been described in detail with reference to the accompanying drawings, the present invention is not limited to the above-described examples. It will be apparent that those skilled in the art to which the present invention pertains can arrive at various modifications or variations within the scope of the technical ideas described in the claims, and it is to be understood that such modifications or variations are also within the technical scope of the present invention.

### (1) First Supplement

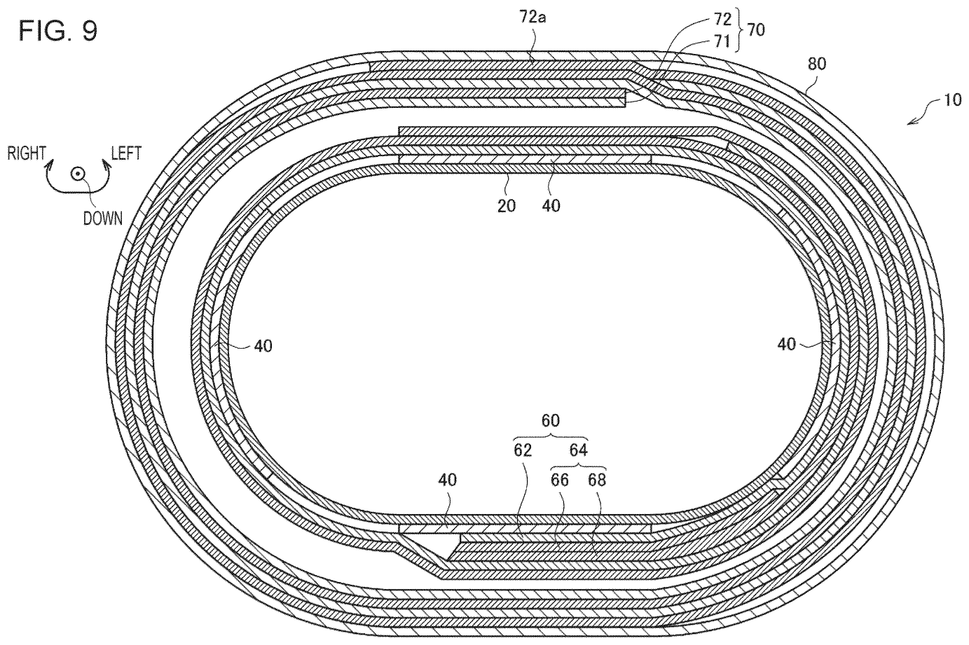

Although the heat insulator 70 is omitted from the structure of the heater assembly 10 in the above-described embodiment, the heater assembly 10 may include the heat insulator 70. The heater assembly 10 including the heat insulator 70 will be described with reference to FIG. 9. FIG. 9 is a schematic diagram illustrating an example of a cross-section of a heater assembly 10 according to a first supplement.

As illustrated in FIG. 9, the heater assembly 10 may include the heat insulator 70 and a thermal contraction tube 80 in addition to the container 20, the heater 40, and the heat diffusion sheet 60. The heater assembly 10 illustrated in FIG. 9 is formed by wrapping the heater 40 and the heat diffusion sheet 60 around the outer side surface of the container 20, and further wrapping the heat insulator 70 and the thermal contraction tube 80 therearound.

The heat insulator 70 is formed by laminating a heat-insulating sheet 71 and a PI tape 72 together. The heat-insulating sheet 71 is an example of a heat-insulating layer having a heat conductivity less than a third threshold. The heat conductivity of the heat-insulating sheet 71 is preferably at least lower than that of the PI tape 64. The third threshold may be, for example, 1 [W/mK], preferably 0.5 [W/mK]. For example, the heat-insulating sheet 71 is composed of a glass material, a vacuum heat insulator, or an aerogel heat insulator. For example, the heat-insulating sheet 71 may be an aerogel sheet composed of an aerogel heat insulator and having a heat conductivity of 0.02 [W/mK]. The PI tape 72 is a tape made of PI. The PI tape 72 is formed by applying an adhesive to one surface of a film-shaped member made of PI.

As illustrated in FIG. 9, the heat insulator 70 is wrapped around the heater 40 and the heat diffusion sheet 60, which are wrapped around the outer side surface of the container 20. More specifically, the heat insulator 70 is wrapped such that the heat-insulating sheet 71 is on the inner side, that the PI tape 72 is on the outer side, and that an adhesive surface of the PI tape 72 faces inward. The PI tape 72 is longer than the heat-insulating sheet 71 in the left-right direction. The PI tape 72 includes a protruding portion 72a that protrudes from the heat-insulating sheet 71 in the left-right direction. The protruding portion 72a is bonded to a portion of the PI tape 72 that is one turn inward from the protruding portion 72a. Thus, the PI tape 72 can fix the heat-insulating sheet 71. According to this structure, the heat insulator 70 can cover the entire outer circumference of the heat diffusion sheet 60. As a result, heat from the heater 40 diffused by the heat diffusion sheet 60 can be prevented from being diffused to the outside of the heat insulator 70.

The thermal contraction tube 80 is a tubular member that contracts when heated. The heater 40 and the heat diffusion sheet 60 are fixed to the container 20 by the thermal contraction tube 80 such that the heater 40 and the heat diffusion sheet 60 are wrapped around the outer side surface of the container 20 and covered by the heat insulator 70. For example, the thermal contraction tube 80 is made of a resin material. When the thermal contraction tube 80 is heated while the heater 40, the heat diffusion sheet 60, the heat insulator 70, and the thermal contraction tube 80 are wrapped around the container 20 in that order, these structural elements can be easily fixed.

### (2) Second Supplement

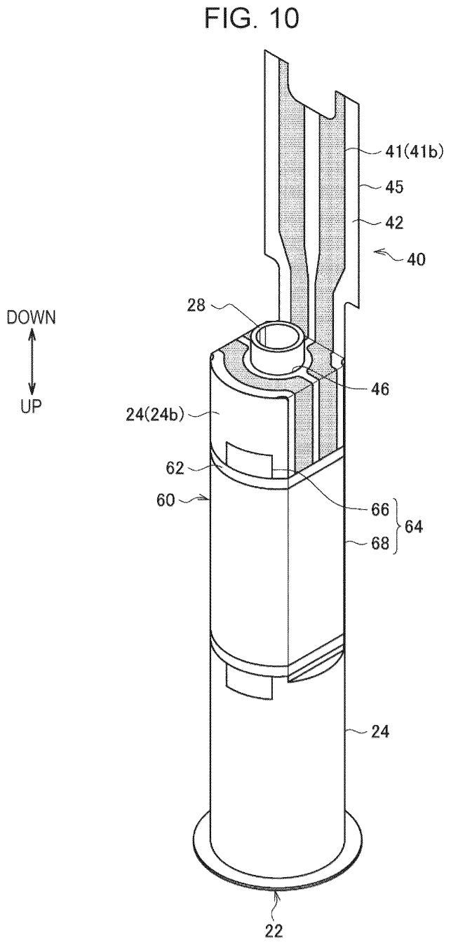

As described in the above embodiment, the heater 40 is disposed on the outer side surface of the container 20 such that a portion of the outer side surface of the container 20 is covered and that another portion of the outer side surface of the container 20 is exposed. However, the shape of the heater 40 to achieve this structure does not include the cutouts 49a and 49b in plan view. As another example, the heater 40 may be formed in a T-shape in plan view. An example of the heater 40 formed in a T-shape will be described with reference to FIGS. 10 to 12.

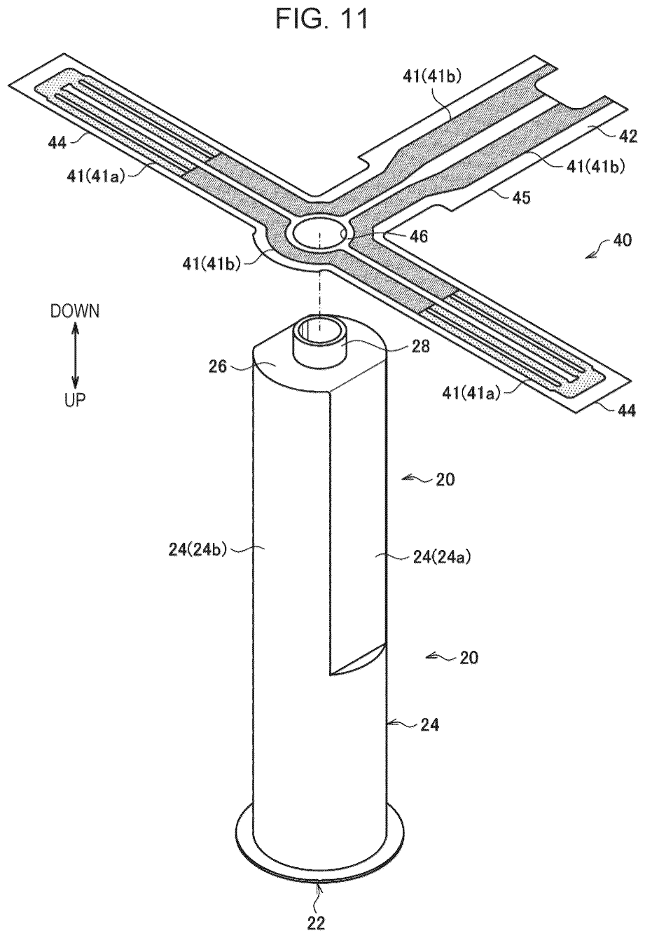

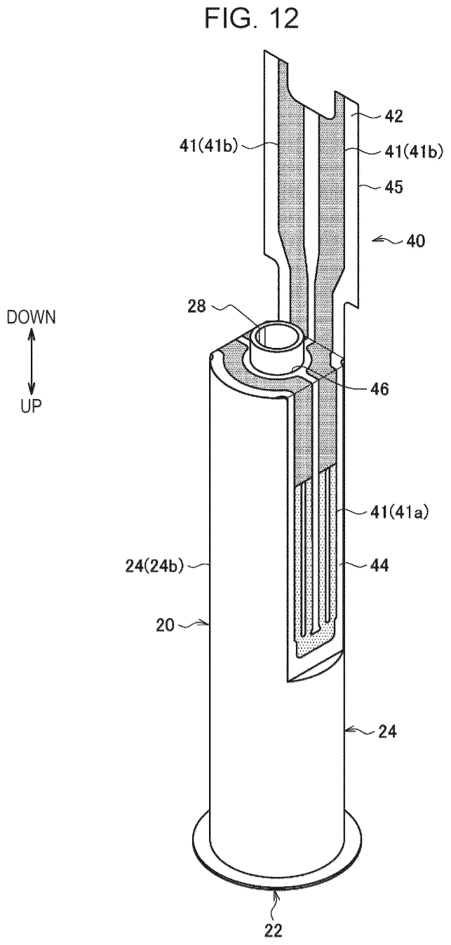

FIG. 10 is a schematic perspective view illustrating an example of a heater assembly 10 according to a second supplement. FIG. 11 is a perspective view illustrating an example of a heater 40 according to the second supplement before attachment to an outer side surface of a container 20. FIG. 12 is a perspective view illustrating an example of the heater 40 according to the second supplement after attachment to the outer side surface of the container 20.

As illustrated in FIG. 10, the heater assembly 10 includes the container 20, the heater 40, and a heat diffusion sheet 60. More specifically, the heater assembly 10 is formed by placing the heater 40 and the heat diffusion sheet 60 on the outer side surface of the container 20.

The structure of the container 20 is similar to that in the above-described embodiment. However, as illustrated in FIGS. 10 to 12, the container 20 has flat portions 24a formed only in a lower region of a side wall 24, and the side wall 24 may be curved in a region above the flat portions 24a.

As illustrated in FIG. 11, the heater 40 has a T-shape in plan view before the heater 40 is bent. As illustrated in FIG. 12, horizontal portions 44 of the T-shape of the heater 40 are bent along the outer surface of the container 20 and disposed to extend along the outer surface of the container 20. As illustrated in FIG. 12, a vertical portion 45 of the T-shape of the heater 40 is bent away from the horizontal portions 44 and is separated from the outer surface of the container 20.

As illustrated in FIG. 11, the heater 40 has a hole 46. More specifically, the hole 46 is formed at the center of the T-shape of the heater 40 before being bent. The conductive track 41 starts from an end portion of the vertical portion 45 of the T-shape of the heater 40, extends along the horizontal portions 44 of the T-shape while bypassing the hole 46, and returns to the end portion of the vertical portion 45 of the T-shape.

As illustrated in FIG. 12, the heater 40 is disposed around the container 20 such that an airflow path 28 provided on a bottom wall 26 of the container 20 extends through the hole 46 in the heater 40. More specifically, the hole 46 in the heater 40 circumscribes the airflow path 28. According to this structure, the heater 40 can be prevented from being displaced.

In addition, as illustrated in FIG. 12, the horizontal portions 44 of the T-shape of the heater are bent to extend along the bottom wall 26 and the flat portions 24a of the container 20. The two flat portions 24a are positioned to face each other, and the horizontal portions 44 of the T-shape of the heater 40 extend along the two flat portions 24a that face each other. According to this structure, the heater 40 is secured to hold the container 20 from the outside of the flat portions 24a that face each other. Thus, the heater 40 can be prevented from being displaced.

The structure of the heat diffusion sheet 60 is similar to that in the above-described embodiment. As illustrated in FIG. 10, the heat diffusion sheet 60 is wrapped around the container on which the heater 40 is disposed such that the graphite sheet 62 is on the inner side. More specifically, the heat diffusion sheet 60 is wrapped around the outer side surface of the container so as to cover the horizontal portions 44 of the T-shape of the heater 40 disposed on the flat portions 24a of the container 20. In the example illustrated in FIG. 10, the vertical PI tape 66 is bonded to a curved portion 24b of the container 20. This arrangement is an example, and the vertical PI tape 66 may be bonded to the heater 40 disposed on one of the flat portions 24a of the container 20.

### (3) Others

In the above-described embodiment, the graphite sheet 62 made of graphite is described as an example of the first layer of the heat diffusion sheet 60. However, the present invention is not limited to this example. The first layer of the heat diffusion sheet 60 may be made of one or more materials selected from a material group including copper, graphite, and aluminum.

In the above-described embodiment, the PI tape 64 made of PI is described as an example of the second layer of the heat diffusion sheet 60. However, the present invention is not limited to this example. The second layer of the heat diffusion sheet 60 may be made of one or more materials selected from a material group including PI, silica, polyester, and glass cloth.

In the above-described embodiment, the heat diffusion sheet 60 is formed by stacking and bonding together the graphite sheet 62 as the bottom layer, the vertical PI tape 66 as the middle layer, and the horizontal PI tape 68 as the top layer. However, the present invention is not limited to this example. The order in which the vertical PI tape 66 and the horizontal PI tape 68 are bonded may be reversed.

The series of processes performed by the individual devices described in this specification may be implemented by using any of software, hardware, and a combination of software and hardware. Programs constituting the software are stored in advance in, for example, a recording medium (specifically, a non-transitory computer-readable storage medium) provided inside or outside each device. When each program is executed by a computer that controls each device described in this specification, for example, the program is read into a RAM and executed by a processing circuit, such as a CPU. The recording medium is, for example, a magnetic disk, an optical disc, a magneto-optical disc, a flash memory, or the like. In addition, the above-described computer programs may be distributed via a network, for example, without using a recording medium. The above-described computer may be an application specific integrated circuit, such as ASIC, a general purpose processor that executes a function by reading a software program, or a computer on a server used for cloud computing. The series of processes performed by the individual devices described in this specification may be distributed and processed by a plurality of computers.

In addition, the process described using a flowchart and a sequence diagram in this specification need not necessarily be executed in the illustrated order. Some processing steps may be executed in parallel. In addition, an additional processing step may be employed, and some processing steps may be omitted.

The following structures are also within the technical scope of the present invention.
(1) An aerosol generating system including:
   a tubular member having an opening allowing insertion of an aerosol generating article containing an aerosol source;
   a heater that is film-shaped and disposed on an outer side surface of the tubular member; and
   a heat diffusion layer in which a first layer and a second layer are laminated together, the first layer having a heat conductivity greater than or equal to a first threshold, the second layer having a tensile strength greater than or equal to a second threshold,
   wherein the heat diffusion layer is wrapped to cover an outer side of the heater disposed on the outer side surface of the tubular member such that the first layer is on an inner side and the second layer is on an outer side.
(2) The aerosol generating system according to (1),
   wherein the second layer is longer than the first layer in a circumferential direction of the tubular member, and
   wherein the heat diffusion layer is formed by bonding the first layer and the second layer such that the second layer covers the first layer over an entire region in the circumferential direction of the tubular member.
(3) The aerosol generating system according to (1) or (2),
   wherein the second layer includes a first portion that is longer than the first layer in a height direction of the tubular member, and
   wherein end portions of the first portion of the second layer protruding from the first layer in the height direction of the tubular member are bonded to the heater.
(4) The aerosol generating system according to (3),
   wherein the heater includes
      an electrically insulating substrate that is film-shaped, and
      a conductive track disposed on the electrically insulating substrate, and
   wherein the end portions of the first portion of the second layer are bonded to blank regions of the heater in which the conductive track is not disposed, the blank regions being adjacent, in the height direction of the tubular member, to a region of the heater in which a heat-producing portion of the conductive track is disposed, the heat-producing portion producing heat when a current is applied.
(5) The aerosol generating system according to any one of (1) to (4),
   wherein the second layer includes a second portion that is longer than an outer circumference of the tubular member in a circumferential direction of the tubular member, and
   wherein the second portion of the second layer includes a protruding portion protruding from the first layer in the circumferential direction of the tubular member, the protruding portion being bonded to a portion of the second layer that is one turn inward from the protruding portion.
(6) The aerosol generating system according to (5),
   wherein the second portion of the second layer is shorter than the first layer in a height direction of the tubular member.
(7) The aerosol generating system according to any one of (1) to (6),
   wherein the first layer is longer than an outer circumference of the tubular member in a circumferential direction of the tubular member.
(8) The aerosol generating system according to any one of (1) to (7),
   wherein the heater includes
      an electrically insulating substrate that is film-shaped, and
      a conductive track disposed on the electrically insulating substrate, and
   wherein the heater is disposed on the outer side surface of the tubular member such that a portion of the outer side surface of the tubular member is covered and that another portion of the outer side surface of the tubular member is exposed.
(9) The aerosol generating system according to (8),
   wherein the heater is formed in a T-shape or a shape having a cutout in plan view.
(10) The aerosol generating system according to any one of (1) to (9), further including:
   a heat-insulating layer having a heat conductivity less than a third threshold; and
   a thermal contraction tube that contracts when heated,
   wherein the heater and the heat diffusion layer are fixed to the tubular member by the thermal contraction tube such that the heater and the heat diffusion layer are wrapped around the outer side surface of the tubular member and covered by the heat-insulating layer.
(11) The aerosol generating system according to any one of (1) to (10),
   wherein the first layer is made of copper, graphite, or aluminum.
(12) The aerosol generating system according to any one of (1) to (11),
   wherein the second layer is made of polyimide (PI).
(13) The aerosol generating system according to any one of (1) to (12),
   wherein the tubular member is made of steel use stainless (SUS).
(14) A method for producing an aerosol generating system, the method including:
   bonding a heat diffusion layer in which a first layer and a second layer are laminated together to a heater that is film-shaped such that the first layer is on an inner side, the first layer having a heat conductivity greater than or equal to a first threshold, the second layer having a tensile strength greater than or equal to a second threshold; and
   placing the heater and the heat diffusion layer that are bonded together on an outer side surface of a tubular member having an opening such that the heater is on an inner side, the opening allowing insertion of an aerosol generating article containing an aerosol source.

### REFERENCE SIGNS LIST

100 inhaler device
111 power supply
112 sensor
113 notifier
114 memory
115 communicator
116 controller
150 stick substrate
151 substrate
152 inhalation port
10 heater assembly
20 container
22 opening
24 side wall (24a: flat portion, 24b: curved portion)
26 bottom wall
28 airflow path
30 internal space
40 heater
41 conductive track (41a: heat-producing portion, 41b: non-heat-producing portion)
42 electrically insulating substrate
43a, 43b blank region
60 heat diffusion sheet
62 graphite sheet
64 PI tape
66 vertical PI tape (66a, 66b: end portion)
68 horizontal PI tape (68a: protruding portion)
70 heat insulator
71 heat-insulating sheet
71 heat-insulating sheet
72 PI tape (72a: protruding portion)
80 thermal contraction tube

1. An aerosol generating system comprising:
a tubular member having an opening allowing insertion of an aerosol generating article containing an aerosol source;
a heater that is film-shaped and disposed on an outer side surface of the tubular member; and
a heat diffusion layer in which a first layer and a second layer are laminated together, the first layer having a heat conductivity greater than or equal to a first threshold, the second layer having a tensile strength greater than or equal to a second threshold,
wherein the heat diffusion layer is wrapped to cover an outer side of the heater disposed on the outer side surface of the tubular member such that the first layer is on an inner side and the second layer is on an outer side.

2. The aerosol generating system according to claim 1,
wherein the second layer is longer than the first layer in a circumferential direction of the tubular member, and
wherein the heat diffusion layer is formed by bonding the first layer and the second layer such that the second layer covers the first layer over an entire region in the circumferential direction of the tubular member.

3. The aerosol generating system according to claim 1,
wherein the second layer includes a first portion that is longer than the first layer in a height direction of the tubular member, and
wherein end portions of the first portion of the second layer protruding from the first layer in the height direction of the tubular member are bonded to the heater.

4. The aerosol generating system according to claim 3,
wherein the heater includes
an electrically insulating substrate that is film-shaped, and
a conductive track disposed on the electrically insulating substrate, and
wherein the end portions of the first portion of the second layer are bonded to blank regions of the heater in which the conductive track is not disposed, the blank regions being adjacent, in the height direction of the tubular member, to a region of the heater in which a heat-producing portion of the conductive track is disposed, the heat-producing portion producing heat when a current is applied.

5. The aerosol generating system according to claim 1,
wherein the second layer includes a second portion that is longer than an outer circumference of the tubular member in a circumferential direction of the tubular member, and
wherein the second portion of the second layer includes a protruding portion protruding from the first layer in the circumferential direction of the tubular member, the protruding portion being bonded to a portion of the second layer that is one turn inward from the protruding portion.

6. The aerosol generating system according to claim 5,
wherein the second portion of the second layer is shorter than the first layer in a height direction of the tubular member.

7. The aerosol generating system according to claim 1,
wherein the first layer is longer than an outer circumference of the tubular member in a circumferential direction of the tubular member.

8. The aerosol generating system according to claim 1,
wherein the heater includes
an electrically insulating substrate that is film-shaped, and
a conductive track disposed on the electrically insulating substrate, and
wherein the heater is disposed on the outer side surface of the tubular member such that a portion of the outer side surface of the tubular member is covered and that another portion of the outer side surface of the tubular member is exposed.

9. The aerosol generating system according to claim 8,
wherein the heater is formed in a T-shape or a shape having a cutout in plan view.

10. The aerosol generating system according to claim 1, further comprising:
a heat-insulating layer having a heat conductivity less than a third threshold; and
a thermal contraction tube that contracts when heated,
wherein the heater and the heat diffusion layer are fixed to the tubular member by the thermal contraction tube such that the heater and the heat diffusion layer are wrapped around the outer side surface of the tubular member and covered by the heat-insulating layer.

11. The aerosol generating system according to claim 1,
wherein the first layer is made of copper, graphite, or aluminum.

12. The aerosol generating system according to claim 1,
wherein the second layer is made of polyimide (PI).

13. The aerosol generating system according to claim 1,
wherein the tubular member is made of steel use stainless (SUS).

14. A method for producing an aerosol generating system, the method comprising:
bonding a heat diffusion layer in which a first layer and a second layer are laminated together to a heater that is film-shaped such that the first layer is on an inner side, the first layer having a heat conductivity greater than or equal to a first threshold, the second layer having a tensile strength greater than or equal to a second threshold; and
placing the heater and the heat diffusion layer that are bonded together on an outer side surface of a tubular member having an opening such that the heater is on an inner side, the opening allowing insertion of an aerosol generating article containing an aerosol source.
